(19) United States
(12) Patent Application Publication
(10) Pub. No.: US 2020/0238469 A1
(43) Pub. Date: Jul. 30, 2020

(54) Method for producing a cutting tool and cutting tool

(71) Applicant: Kennametal Inc., Latrobe, PA (US)

(72) Inventor: Tim GUTER, Fuerth (DE)

(21) Appl. No.: 16/776,999

(22) Filed: Jan. 30, 2020

(30) Foreign Application Priority Data
Jan. 30, 2019 (DE) 102019102334.3

(51) Int. Cl. B24B 3/34; B23B 27/16

(52) U.S. Cl. CPC B24B 3/34; B23B 27/16

(57) ABSTRACT

A method for producing a cutting tool with a cutting edge that is formed at least in sections by an end face and a flute comprises the following sequence: Processing of the end face by means of grinding, and polishing of the flute by means of a flute polishing. Here, the flute polishing is carried out by means of a polishing wheel, wherein the polishing wheel is guided during the polishing in such a way that it is moved over the cutting edge and, at least in sections, a final edge rounding on the cutting edge is produced. Further, a cutting tool is disclosed that has been produced according to such a method.

### RELATED APPLICATION DATA

The present application claims priority pursuant to 35 U.S.C. § 119(a) to German Patent Application No. 102019102334.3 filed Jan. 30, 2019, which is incorporated herein by reference in its entirety.

### FIELD

The invention relates to a method for producing a cutting tool with a cutting edge that is formed at least in sections by an end surface and a flute. Furthermore, the invention relates to a cutting tool produced according to such a method.

### BACKGROUND

Cutting tools, in particular cutting tools for machining, such as drills, are known, as are methods for their manufacture.

It is further known to produce cutting tools with rounded cutting edges. Cutting edges with a cutting edge rounding have the advantage that the cutting edge is better protected against breaking, which increases the lifetime of the cutting tool. For this purpose, the cutting edges are usually processed by means of sand blasting or brushing in a final processing step in order to create a corresponding cutting edge rounding. However, these methods have the disadvantage that they damage the surface quality of the areas of the cutting tool adjacent to the cutting edge. Further, an additional process step is required for the cutting edge rounding, which requires a more involved manufacturing process.

### SUMMARY

The task of the invention is to provide a method for producing a cutting tool with a cutting edge rounding that is particularly efficient and leads to an improved surface quality of the cutting tool. The task of the invention is further to provide a cutting tool that has been produced by means of such a method.

To solve these tasks, a method is provided for producing a cutting tool with a cutting edge that is formed at least in sections by an end face and a flute, with the following sequence:
a) processing of the end face by means of grinding, and
b) polish-grinding of the flute by means of a flute polishing.
   The flute polishing is carried out by means of a polishing wheel, wherein the polishing wheel is guided during the polishing in such a way that it is moved over the cutting edge and, at least in sections, a final edge rounding on the cutting edge is produced. By moving the polishing wheel over the cutting edge during the polishing of the flute, at least one section of the polishing wheel adjacent to the cutting edge protrudes over the cutting edge opposite to the flute, whereby the cutting edge is also processed by the polishing wheel during the polish-grinding of the flute. In this way, the cutting tool can be produced very efficiently, because the production of the edge rounding on the cutting edge occurs in one processing step with the polishing of the flute. Further, the cutting edge rounding is completed by this process step in the corresponding section, i.e. finally, so that no further processing steps are necessary for the edge rounding on this section of the cutting edge. Thus, the areas adjacent to the cutting edge, which are formed here by the end face and the flute, maintain their high surface quality, which was produced accordingly by the grinding of the end face and polish-grinding of the flute.

In one embodiment, the section of the cutting edge that is formed by the end face and the flute can form a main cutting edge of the cutting tool. The main cutting edges of a cutting tool are usually subjected to the greatest load and the highest wear. Therefore, a high surface quality as well as a high-quality edge rounding, as provided with the aforementioned manufacturing method, are particularly advantageous for these cutting edges and can lead to a longer lifetime and a higher quality of the cutting tool.

In a further embodiment, the cutting tool has a gash that is adjacent to the flute and/or the end face. The gash is processed by means of grinding before step b), i.e. before the polish-grinding of the flute and thus before the cutting edge rounding is produced. In this way, it can be ensured that the quality of the cutting edge rounding is not impaired during the grinding of the gash.

Further, a section of the cutting edge can be formed by the end face and the gash. As a result, depending on the geometry of the polishing wheel and the cutting edge, the section of the cutting edge that is formed by the end face and the gash can, at least in sections, be rounded along with the section of the cutting edge that is formed by the end face and the flute during the polish-grinding of the flute in step b), particularly when the two corresponding sections are adjacent to one another. Thus, the efficiency of the manufacturing process and the quality of the cutting edge and cutting tool can be further increased.

Preferably, the edge rounding of the cutting edge has a K factor greater than 1. The cutting edge is thus protected and, at the same time, especially high-cutting, i.e. the required cutting force for the machining process is especially low.

It is particularly preferred here for the edge rounding to have a K factor between 1.5 and 3, in particular between 1.9 and 2.1, because the ratio of lifetime to high-cutting ability is particularly advantageous in these areas.

According to one embodiment, the polishing wheel is moved along the flute and beyond the cutting edge. This direction of travel of the polishing wheel during polish-grinding of the flute results in an edge rounding of a particularly high quality.

The cutting tool can be a drill, in particular a spiral drill.

According to the invention, a cutting tool is also provided for solving the aforementioned problem, said tool having been produced according to the inventive method and thus having the advantages described above.

### BRIEF DESCRIPTION OF THE DRAWINGS

Further advantages and features can be found in the following description in conjunction with the attached drawings. The drawings show:

FIG. 1 a schematic view of a cutting tool produced according to the invention, having a cutting edge with an edge rounding, and

FIG. 2 a sectional view of the cutting edge with the edge rounding from FIG. 1.

### DETAILED DESCRIPTION

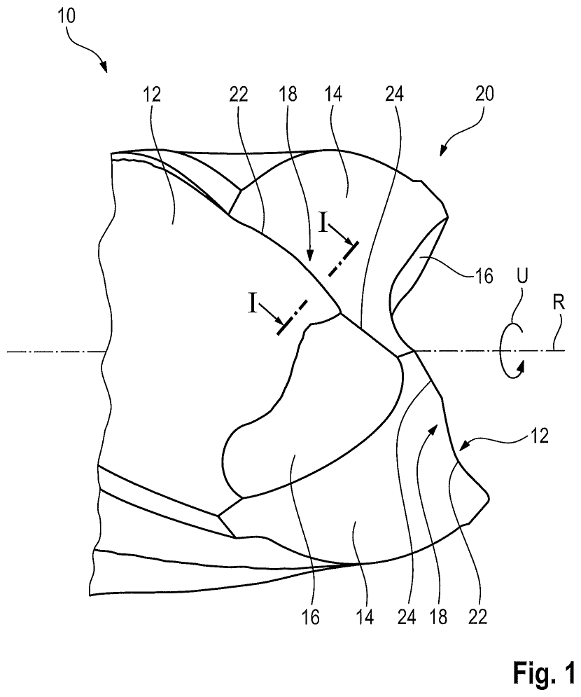

FIG. 1 shows a cutting tool 10 with a flute 12, an end face 14, a gash 16, and a cutting edge 18.

In the present exemplary embodiment, the cutting tool 10 is a spiral drill with a drill tip 20, wherein FIG. 1 only shows the section of the spiral drill with the drill tip 20.

The cutting tool 10 extends along a longitudinal axis R, which simultaneously defines a rotational axis in order to rotate the cutting tool 10 during operation. Here, the circumferential direction U is the rotational direction of the cutting tool 10 provided for the machining by means of the cutting edge 18.

The cutting tool 10 is designed symmetrically around the longitudinal axis R at an angle of 180°, i.e. the cutting tool 10 has two flutes 12, end faces 14, gashes 16, and cutting edges 18, respectively.

Due to the symmetrical structure, the cutting tool 10 is illustrated in the following by means of one of the cutting edges 18, although these explanations are equally applicable for all cutting edges 18 as well as all corresponding features.

The cutting edge 18 has an abaxial cutting edge section 22 and a paraxial cutting edge section 24, which cross into one another.

The abaxial cutting edge section 22 is formed by the end face 14 and the flute 12, wherein the end face 14 forms the open surface and the flute 12 forms the cutting surface in this section of the cutting edge 18.

The paraxial cutting edge section 24 is formed by the end face 14 and the gash 16, wherein the end face 14 forms the open surface and the gash 16 forms the cutting surface in this section of the cutting edge 18.

In an alternative embodiment, in particular one in which no corresponding gash 16 is provided, the cutting edge 18 can be formed completely or at least in sections by the end face 14 and the flute 12, wherein the end face 14 forms the open surface and the flute 12 the cutting surface of the cutting edge 18.

The cutting edge 18 is a main cutting edge of the cutting tool 10.

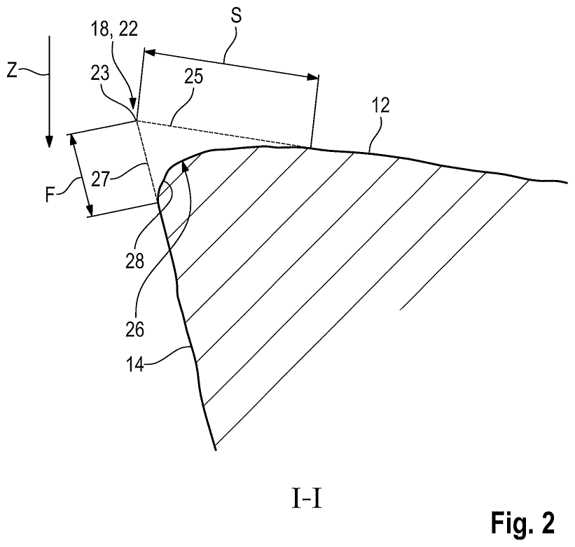

The cutting edge 18 has an edge rounding 26 (see FIG. 2) with a K factor of 2.0.

FIG. 2 shows a sectional view through the abaxial cutting edge 22 on the plane I-I (see FIG. 1), wherein the profile of the cutting edge 18, 22 is shown by a dashed line in a state without the edge rounding 26.

The K factor is defined by k=S/F. Here, S is the distance of the extension lines 25 of the rounded section of the cutting surface and F is the distance of the extension lines 27 of the rounded section of the open surface, which extend respectively from the corresponding surface, i.e. the cutting surface or the open surface, to the theoretical cutting edge 23 without the edge rounding. The theoretical cutting edge 23 without edge rounding is formed by the intersection of the dashed extension lines 25, 27, which form the course of the cutting surface and the open surface, respectively, without the edge rounding 26.

If the K factor is not equal to 1, the edge rounding 26 is asymmetrical and, in the profile view, has a course that corresponds to the section of an ellipse.

Therefore, the K factor can alternatively be defined by the ratio of the main axial length to the auxiliary axial length of the corresponding ellipsis.

In the present embodiment, the edge rounding 26 extends with a constant K factor over the entire cutting edge 18.

In an alternative embodiment, the cutting edge 18 can have an edge rounding 26 only in sections, in particular in the abaxial cutting edge section 22.

In addition, or alternatively, the edge rounding 26 can have a K factor that varies over the course of the cutting edge 18, i.e. the cutting edge 18 has multiple sections that have an edge rounding 26 with different K factors.

Preferably, the K factor of the edge rounding 26 has a value greater than 1, at least in sections and particularly in the abaxial cutting edge section 22.

It is further preferred for the K factor of the edge rounding 26 to have a value between 1.5 and 3, in particular between 1.9 and 2.1, at least in sections and particularly in the abaxial cutting edge section 22.

In principle, the cutting tool 10 can, in an alternative embodiment, be an arbitrary cutting tool 10 with at least one flute 12 and an end face 14, which together form a cutting edge 18. In particular, the cutting tool 10 can be an arbitrary drill.

In addition, or alternatively, the cutting tool 10 can be designed as a single piece or as having multiple pieces and can consist, for example, of a base body and a drill head attached exchangeably to the base body. Further, the cutting tool 10 can have an arbitrary rotational geometry.

In the following, a method is described whereby the cutting tool 10 can be produced.

First, a blank of the cutting tool 10 is produced, in particular by means of a sintering process, which is subsequently further processed by means of machining.

Here, the end face 14 and the gash 16 are polished simultaneously or in an arbitrary order, in particular by means of a grinding wheel.

In a subsequent step, the flute 12 is ground and polished by means of a flute polishing. This flute polishing is carried out by means of a polishing wheel (not shown), which is driven along the longitudinal axis R as well as along the flute 12 in such a manner that the material is stripped away, i.e. in contact with the cutting tool 10.

Here, the polishing wheel is moved beyond the abaxial cutting edge 22, so that the polishing wheel is not only in contact with the abaxial cutting edge 22, but also protrudes in sections over the abaxial cutting edge 22 opposite to the flute 12. As a result, the polishing wheel slips over the cutting edge 18, at least in sections, whereby the edge rounding 26 is produced in the corresponding section of the cutting edge 18.

This section of the cutting edge 18, which has been rounded in this way by the polishing of the flute 12, has at least one final edge rounding 26. That is to say, the edge rounding 26 has the desired or predetermined K factor in this section and, in particular, does not need to be reworked.

Sections of the cutting edge 18, in particular the paraxial cutting edge section 24, which have no edge rounding 26 with a predetermined K factor, can be rounded in an optional step before and/or after the flute polishing, for example by means of brushing or sand blasting.

In a further optional step, the cutting tool 10 can be coated subsequent to the machining, for example with a PVD coating, in order to increase the wear resistance.

Preferably, a polishing wheel with an elastic grinding surface is used for the flute polishing, wherein during the grinding process, the polishing wheel extends transversely to the flute 12 beyond the cutting edge 18 in a direction Z (see FIG. 2), thus producing the section 28 of the edge rounding 26 adjacent to the end face 14.

The advantage of this manufacturing method is that the edge rounding 26 is formed in one step with the polishing of the flute 12, whereby the cutting tool 10 is produced in a particularly efficient and cost-effective manner.

Further, the cutting tool 10 has an improved surface quality, because the edge rounding 26 is produced, at least in sections, without additional process steps, which could otherwise negatively affect the surface quality.

The invention is not limited to the embodiment shown. In particular, individual features of an embodiment may be contained in a further inventive embodiment, independent of the other features of the respective embodiment, i.e. the features described can be combined arbitrarily.

1. A method for producing a cutting tool with a cutting edge that is formed at least in sections by an end face and a flute, comprising:
a) processing of the end face by means of grinding, and
b) polishing of the flute by means of a flute polishing, wherein the flute polishing is carried out by means of a polishing wheel, and the polishing wheel is guided during the polishing in such a way that the polishing wheel is moved over the cutting edge and, at least in sections, produces a final edge rounding on the cutting edge.

2. The method according to claim 1, characterized in that the section of the cutting edge formed by the end face and flute forms a main cutting edge of the cutting tool.

3. The method according to claim 1, characterized in that the cutting tool has a gash, wherein the gash is processed by means of grinding before step b).

4. The method according to claim 3, characterized in that the cutting edge is formed in sections by the end face and the gash.

5. The method according to claim 1, characterized in that the edge rounding has a K factor greater than 1.

6. The method according to claim 5, characterized in that the edge rounding has a K factor between 1.5 and 3, in particular between 1.9 and 2.1.

7. The method according to claim 1, characterized in that the polishing wheel is moved along the flute.

8. The method according to claim 1, characterized in that the cutting tool is a drill.

9. A cutting tool produced according to a method according to claim 1.
